(19) United States
(12) Patent Application Publication
(10) Pub. No.: US 2016/0082917 A1
(43) Pub. Date: Mar. 24, 2016

(54) MAGNETIC RETENTION ASSEMBLY FOR A CURTAIN AIRBAG

(71) Applicant: Nissan North America, Inc., Franklin, TN (US)

(72) Inventor: PAUL SLAATS, ANN ARBOR, MI (US)

(21) Appl. No.: 14/492,126

(22) Filed: Sep. 22, 2014

(51) Int. Cl. B60R 21/232

(52) U.S. Cl. CPC B60R 21/232; B60R 2021/161

(57) ABSTRACT

A vehicle comprises a body structure defining a window opening, a curtain airbag for the window opening, and a magnetic retention assembly for retaining the curtain airbag to the body structure upon its deployment. The curtain airbag is sized to overlap some of the body structure upon its deployment. The magnetic retention assembly has a first retaining portion positioned at a portion of the body structure overlapped by the curtain airbag, and a second retaining portion positioned at the curtain airbag. The second retaining portion is magnetically attractable to the first retaining portion.

### TECHNICAL FIELD

The disclosure relates to the field of inflatable restraints for vehicles.

### BACKGROUND

Inflatable restraint devices commonly called airbags are standard equipment on most new vehicles. In early implementations of airbag systems, vehicles were equipped with one or more airbags that would deploy from forward-facing regions such as the steering wheel and the passenger side of the instrument panel.

In more recent implementations, additional airbags have been employed in different areas of the vehicle. For example, curtain airbags have been utilized to provide energy dissipation capacity along the sides of vehicles. Curtain airbags have been employed in areas adjacent to the roof rail and headliner or the side doors. These curtain airbag devices are typically concealed from occupant view prior to deployment by interior trim panels associated with the roof rail and/or headliner. When a curtain airbag is deployed, it is inflated with a gas, which pressurizes the curtain airbag and induces surface tension in the material from which the curtain airbag is fabricated.

### SUMMARY

Disclosed herein are embodiments of curtain airbags and vehicles with curtain airbags. In one aspect, a vehicle comprises a body structure defining a window opening, a curtain airbag for the window opening, and a magnetic retention assembly for retaining the curtain airbag to the body structure upon its deployment. The curtain airbag is sized to overlap some of the body structure upon its deployment. The magnetic retention assembly has a first retaining portion positioned at a portion of the body structure overlapped by the curtain airbag, and a second retaining portion positioned at the curtain airbag. The second retaining portion is magnetically attractable to the first retaining portion.

In another aspect, a vehicle comprises a body structure defining a side window opening, a side curtain airbag for the side window opening, and a magnetic retention assembly for retaining the side curtain airbag to the body structure upon its deployment. The body structure forms a beltline framing a bottom of the side window opening. The side curtain airbag is mounted at the top of the window opening and sized to span the height of the side window opening and have a lower periphery overlap the beltline upon its deployment. The magnetic retention assembly has a first retaining portion positioned at the beltline, and a second retaining portion positioned at the lower periphery of the side curtain airbag. The second retaining portion is magnetically attractable to the first retaining portion.

In yet another aspect, a vehicle comprises a body structure defining a window opening and a curtain airbag for the window opening. The curtain airbag is sized to overlap some of the body structure upon its deployment. The vehicle further comprises a first retaining portion housed by a portion of the body structure overlapped by the curtain airbag, and a second retaining portion configured for magnetic attraction to the first retaining portion and connected with the curtain airbag for proximity with the first retaining portion upon the curtain airbag's deployment.

These and other aspects will be described in additional detail below.

### BRIEF DESCRIPTION OF THE DRAWINGS

The description herein makes reference to the accompanying drawings wherein like referenced numerals refer to like parts throughout the several views, and wherein:

FIG. 1 is a side view of an interior of a vehicle having a body structure defining a window opening and equipped with a curtain airbag assembly including a curtain airbag for the window opening;

FIG. 2 is a rear sectional view of the vehicle taken along the line A-A in FIG. 1 showing the curtain airbag in a pre-deployment position;

FIG. 3 is a partial side view of the interior of a vehicle showing the curtain airbag assembly during deployment of the curtain airbag, and showing examples of retention zones where a magnetic retention assembly can be implemented to retain the curtain airbag to the body structure upon deployment;

FIG. 4 is a rear sectional view of the vehicle taken along the line A-A in FIG. 1 showing the curtain airbag assembly during deployment of the curtain airbag;

FIGS. 5 and 6 are detailed sectional views of the vehicle taken along the lines A-A and B-B in FIG. 1, respectively, showing example implementations of the magnetic retention assembly;

FIG. 7 is a schematic of a system for deploying the curtain airbag and actuating an example of the magnetic retention assembly employing an electromagnet; and

FIG. 8 is a flow diagram showing operations for deploying the curtain airbag and actuating the example of the magnetic retention assembly employing an electromagnet.

### DETAILED DESCRIPTION

The curtain airbags employed along the sides of vehicles, or so called side curtain airbags, may be utilized to provide coverage over a vehicle's side window opening upon deployment. The vehicle according to the description that follows includes a magnetic retention assembly for retaining the side curtain airbag to the vehicle's body structure upon the side curtain airbag's deployment.

Although the following example is directed to a magnetic retention assembly implemented with a side curtain airbag, it will be understood that this example is non-limiting. The disclosed construction and operation of the magnetic retention assembly is equally applicable in principle, for instance, for implementation with other curtain airbags utilized to provide coverage over other window openings or in other parts of the vehicle.

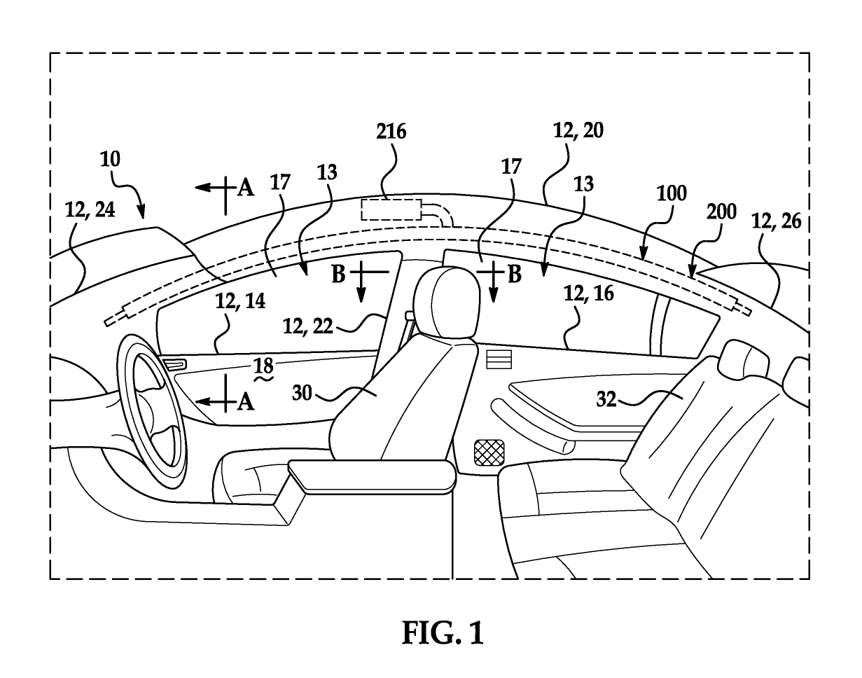

FIGS. 1-4 show a vehicle 10 having a restraint system that includes a side curtain airbag assembly 100 having a side curtain airbag 200. The vehicle 10 may include a body structure 12 that is at least partially open to define one or more window openings 13. The body structure 12 may include a front door 14 and a rear door 16, each of which define a respective window opening 13 and accommodates a window 17. As shown, the front door 14 and the rear door 16 of the body structure 12 frame the tops of the respective window openings 13 and form a beltline 18 framing the bottoms of the respective window openings 13. The body structure 12 may further include a roof rail 20 extending along the longitudinal direction of the vehicle 10, above the front door 14 and the rear door 16.

The front door 14 and the rear door 16 can be separated from one another by an upright interior structural pillar or B-pillar 22 of the vehicle body structure 12 extending from the beltline 18 to the roof rail 20. An upright front structural pillar or A-pillar 24 of the vehicle body structure 12 is disposed forward of the front door 14. An upright rear structural pillar or C-pillar 26 of the vehicle body structure 12 is disposed rearward of the rear door 16. In this description, references to both the body structure 12 generally and to specific components of the body structure 12 (e.g., the front door 14, the rear door 16, the roof rail 20, the A-pillar 24, the B-pillar 22 or the C-pillar 26) should be understood as encompassing structural components as well as any exterior or interior panels, upholstery or trim pieces.

Front seats 30 are positioned adjacent to the front door 14, and rear seats 32 are positioned adjacent to the rear door 16. The side curtain airbag assembly 100 could be used with other vehicles, such as vehicles that do not include a rear door 16 but include rear seats 32, or vehicles that lack both a rear door 16 and rear seats 32.

According to the example of the vehicle 10 with the illustrated body structure 12 and configuration of the side curtain airbag assembly 100, as used in the discussion of the curtain airbag 200 of the side curtain airbag assembly 100, the term window opening 13 can refer generally to the combination of the window openings 13 defined by the front door 14 and the rear door 16. For other examples of the vehicle 10 and/or configurations of the side curtain airbag assembly 100, the term window opening 13 could refer generally to an individual window opening 13 or to different combinations of window openings 13, including those not defined by the front door 14 or the rear door 16.

The curtain airbag assembly 100 is generally disposed at the top of the window openings 13. In the illustrated example, for instance, the curtain airbag 200 and other components of the side curtain airbag assembly 100 are disposed along the roof rail 20 of the vehicle 10, at least partially behind a headliner 40, with the curtain airbag 200 extending along the roof rail 20 and underneath the headliner 40 in the longitudinal direction of the vehicle 10, at the top of the window openings 13 and just above the front door 14 and the rear door 16 as well as the A-pillar 24, the B-pillar 22 or the C-pillar 26.

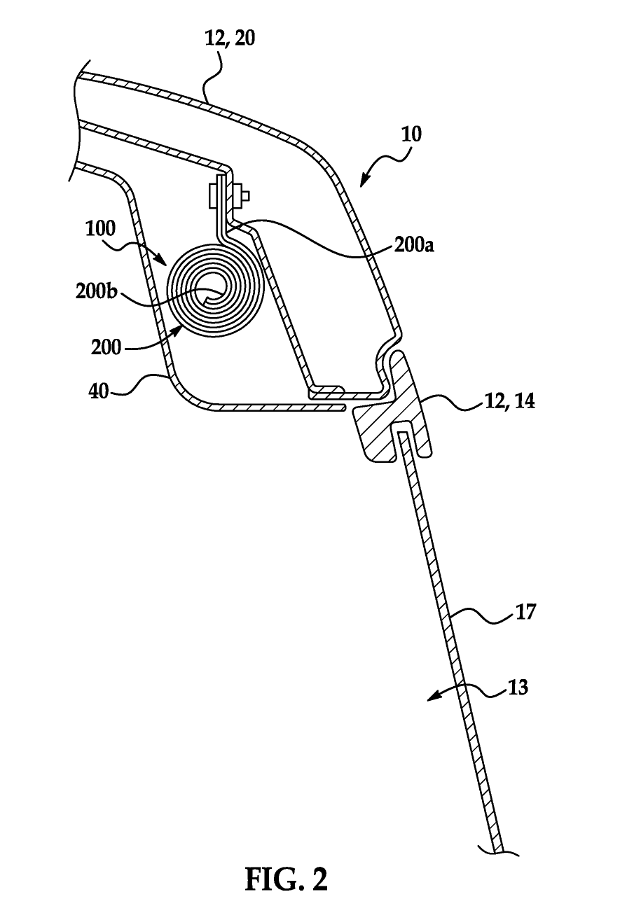

As shown in FIGS. 1 and 2, prior to deployment, the side curtain airbag assembly 100 is disposed in a pre-deployment position. In the pre-deployment position, the curtain airbag 200 of the side curtain airbag assembly 100 can be hidden from view within the interior of the vehicle 10. The curtain airbag 200 can be folded, rolled, or otherwise compressed into a compact state when the side curtain airbag assembly 100 is disposed in its pre-deployment position.

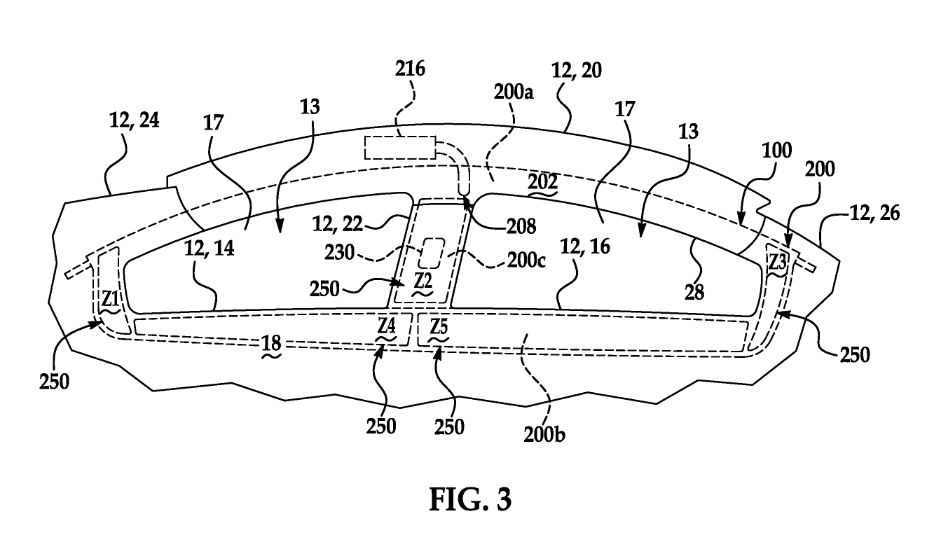

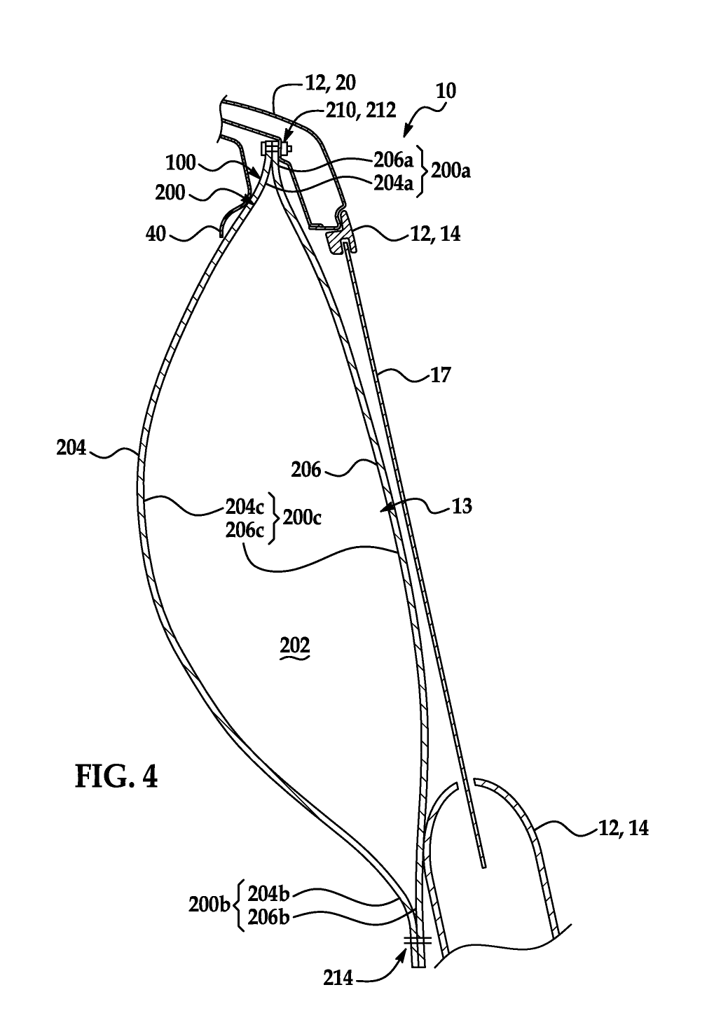

As shown in FIGS. 3 and 4, during deployment of the curtain airbag 200, the curtain airbag 200 is inflated. Specifically, the curtain airbag 200 has one or more internal inflatable chambers which are inflated by the selective rapid introduction of inflation gas. The inflation causes the headliner 28 to be displaced, such as by bending the headliner 28, thereby exposing the curtain airbag 200 to the passenger compartment of the vehicle 10. The inflation further causes the curtain airbag 200 to enter the passenger compartment of the vehicle 10.

The side curtain airbag assembly 100 is generally configured to provide coverage over the window opening 13 upon inflation and the ensuing entry of the curtain airbag 200 into the passenger compartment of the vehicle 10 in order to accommodate one or more events for the vehicle 10. In the illustrated example, the curtain airbag 200 is mounted at the top of the window opening 13 and is sized to extend in the longitudinal direction of the vehicle 10 and span the height of the window opening 13 to provide coverage over the entirety of the window opening 13. The curtain airbag 200 has an upper periphery 200a that extends in the longitudinal direction of the vehicle 10 above the upper portions of the window opening 13, an opposing lower periphery 200b that extends in the longitudinal direction of the vehicle 10 below the bottom of the window opening 13 and a central portion 200c between the upper periphery 200a and the lower periphery 200b.

According to the illustrated example construction of the curtain airbag 200, the curtain airbag 200 may include an inflatable chamber 202 defined between an inner panel 204 facing the interior of the vehicle 10 and an opposing outer panel 206 facing toward the window opening 13. The curtain airbag 200 defines an inflation aperture 208 in communication with the inflatable chamber 202 in order to support the inflation of the curtain airbag 200.

The inner panel 204 has an upper periphery 204a, an opposing lower periphery 204b and a central portion 204c between the upper periphery 204a and the lower periphery 204b. The outer panel 206 similarly has an upper periphery 206a, an opposing lower periphery 206b and a central portion 206c between the upper periphery 206a and the lower periphery 206b. The material properties of the inner panel 204 and the outer panel 206, including but not limited to permeability to inflation gas, can be selected, for example, to allow the inflatable chamber 202 to maintain a surface tension conducive to providing among other things a countermeasure in an ejection mitigation system for the vehicle 10.

As shown, the respective upper periphery 204a and upper periphery 206a of the inner panel 204 and the outer panel 206 are connected to one another by a seam 210 at the upper periphery 200a of the curtain airbag 200 and are attached to the body structure 12 of the vehicle 10 with an attachment 212. The attachment 212 can be implemented with a fastener as generally shown with other types of attachments, and the seam 210 can be implemented with sewing, stitching, an adhesive, hook and loop type fasteners, staples, grommets and/or rivets, for instance, either alone or in combination with the attachment 212. The respective lower periphery 204b and lower periphery 206b of the inner panel 204 and the outer panel 206 are connected to one another by a seam 214 at the lower periphery 200b of the curtain airbag 200. The seam 214, similarly to the seam 210, can be implemented with sewing, stitching, an adhesive, hook and loop type fasteners, staples, grommets and/or rivets, for instance.

With the illustrated configuration, the curtain airbag 200 provides coverage over the window opening 13 and overlaps, in a transverse direction of the vehicle 10, some of the body structure 12. For instance as best shown in FIG. 3, one or more of the A-pillar 24, the B-pillar 22 and the C-pillar 26 can be wholly or partially overlapped by the central portion 200c and the lower periphery 200b of the curtain airbag 200. The portions of the front door 14 and the rear door 16 forming the beltline 18 can moreover be wholly or partially overlapped by the lower periphery 200b of the curtain airbag 200.

With reference to FIG. 3, the curtain airbag assembly 100 of the illustrated example of the vehicle 10 includes a magnetic retention assembly 250 for retaining the curtain airbag 200 to the body structure 12 of the vehicle 10 upon the deployment of the curtain airbag 200. The magnetic retention assembly 250 is generally configured to inhibit outward transverse movement of the curtain airbag 200 into and/or beyond the area of the window opening 13, either alone or in combination with the curtain airbag 200 overlapping some of the body structure 12. The magnetic retention assembly 250 may, among other things, support the example provision of the curtain airbag 200 as a countermeasure in an ejection mitigation system for the vehicle 10.

The magnetic retention assembly 250 may implement one or more magnetic retention zone(s) Z1, Z2, Z3, Z4 and/or Z5 for the curtain airbag 200. Each of the magnetic retention zones Z1-Z5 borders the window opening 13, and is implemented at portions of the body structure 12 overlapped by the curtain airbag 200 in order to retain corresponding overlapping portions of the curtain airbag 200 to the body structure 12. The magnetic retention assembly 250 may implement each of the magnetic retention zones Z1-Z5, as generally depicted in FIG. 3, or may implement any one of the magnetic retention zones Z1-Z5 by itself or any combination of the magnetic retention zones Z1-Z5. It will also be understood that the magnetic retention zones Z1-Z5 themselves are given as non-limiting examples, and that in other examples the magnetic retention assembly 250 can implement fewer or additional magnetic retention zones and/or magnetic retention zones with alternative sizes.

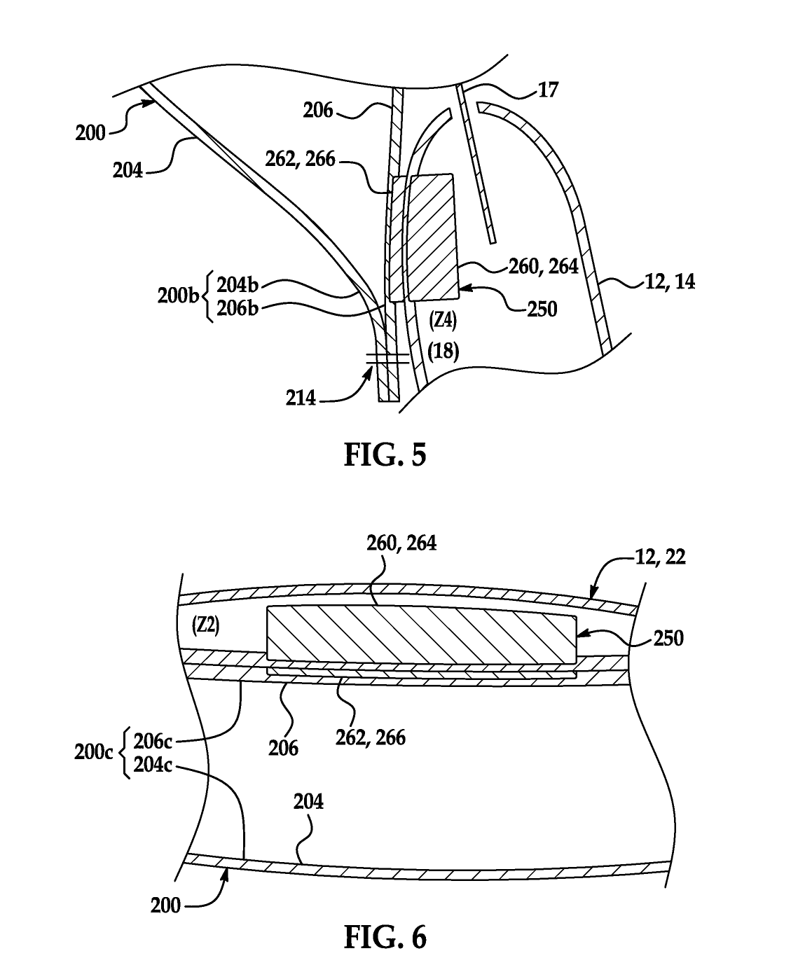

An example implementation of the magnetic retention zone Z4 by the magnetic retention assembly 250 is shown in FIG. 5. In accordance with the illustrated and above described configuration of the vehicle 10 and the curtain airbag 200, the magnetic retention zone Z4 is implemented at the portion of the front door 14 forming the beltline 18 with respect to corresponding overlapping portions of the lower periphery 200b of the curtain airbag 200. The example implementation of the magnetic retention zone Z4 by the magnetic retention assembly 250 is also generally representative of the implementation of the magnetic retention zone Z5 at the portion of the rear door 16 forming the beltline 18 with respect to corresponding overlapping portions of the lower periphery 200b of the curtain airbag 200.

An example implementation of the magnetic retention zone Z2 by the magnetic retention assembly 250 is shown in FIG. 6. In accordance with the illustrated and above described configuration of the vehicle 10 and the curtain airbag 200, the magnetic retention zone Z2 is implemented at the B-pillar 22 with respect to corresponding overlapping portions of the central portion 200c of the curtain airbag 200. Additionally, or alternatively, it will be understood that the magnetic retention zone Z2 may be similarly implemented at the B-pillar 22 with respect to corresponding overlapping portions of the lower periphery 200b of the curtain airbag 200. The example implementation of the magnetic retention zone Z2 by the magnetic retention assembly 250 is also generally representative of the implementation of the magnetic retention zone Z1 at the A-pillar 24 with respect to corresponding overlapping portions of the central portion 200c and/or lower periphery 200b of the curtain airbag 200, and of the implementation of the magnetic retention zone Z3 at the C-pillar 26 with respect to corresponding overlapping portions of the central portion 200c and/or lower periphery 200b of the curtain airbag 200.

As generally indicated by the examples of FIGS. 5 and 6, the magnetic retention assembly 250 includes a first retaining portion 260 positioned at the body structure 12. The first retaining portion 260 can be positioned continuously or at any number of discrete locations throughout the body structure 12 where a given magnetic retention zone Z1-Z5 is implemented by the magnetic retention assembly 250 (e.g., the portion of the front door 14 forming the beltline 18 in FIG. 5 or the B-pillar 22 in FIG. 6). The magnetic retention assembly 250 further includes a second retaining portion 262 positioned at corresponding overlapping portions of the curtain airbag 200. The second retaining portion 262, similarly to the first retaining portion 260, can be positioned continuously or at any number of discrete locations at the corresponding overlapping portions of the curtain airbag 200 (e.g., the lower periphery 200b of the curtain airbag 200 in FIG. 5 or the central portion 200c of the curtain airbag 200 in FIG. 6).

The first retaining portion 260 is magnetically attractable to the second retaining portion 262 so that the curtain airbag 200 is retained to the body structure 12 of the vehicle 10 upon deployment of the curtain airbag 200. The retention of the curtain airbag 200 to the body structure 12 resulting from the magnetic attraction between the first retaining portion 260 and the second retaining portion 262 can be configured to avoid or otherwise inhibit outward transverse movement of the curtain airbag 200 into and/or beyond the area of the window opening 13.

The first retaining portion 260 of the magnetic retention assembly 250 may for example be, or include, one or more magnets 264 housed by the body structure 12. According to the illustrated example, the one or more magnets 264 can be positioned at least partially within the body structure 12. According to this example, the one or more magnets 264 can be enclosed by the body structure 12, out of view from a user of the vehicle 10, or partially integrated with an interior facing surface of the body structure 12. In other examples, the one or more magnets 264 could be wholly integrated with an interior facing surface of the body structure 12.

The second retaining portion 262 of the magnetic retention assembly 250 may be, or include, one or more magnetic structures 266 connected with the curtain airbag 200. According to the illustrated example, the one or more magnetic structures 266 can be positioned at the surface of the outer panel 206 facing the body structure 12. In other examples, the one or more magnetic structures 266 could be enclosed by the curtain airbag 200 or incorporated into the material of the curtain airbag 200, for instance. In some implementations, the one or more magnetic structures 266 can be rod-like and sewed, stitched, adhered or otherwise connected with the curtain airbag 200. In other implementations, the one or more magnetic structures 266 could be applied to the curtain airbag 200 by spraying or printing, for example. In any of the above described examples and implementations, the one or more magnetic structures 266 could be rigid, for instance, or flexible so as to adapt in shape to the contours of the body structure 12.

The one or more magnetic structures 266 of the second retaining portion 262 are generally configured for magnetic attraction to the one or more magnets 264 of the first retaining portion 260. The one or more magnetic structures 266 may for example include magnetic material. The magnetic material of the one or more magnetic structures 266 in this example could itself be a magnet, for instance, or could be a material otherwise magnetically attracted to magnets (e.g., a ferrimagnetic or ferromagnetic material). It is to be understood that the description of the first retaining portion 260 of the magnetic retention assembly 250 being, or including, one or more magnets 264, and of the second retaining portion 262 being, or including, one or more magnetic structures 266, is provided as a non-limiting example. In alternative examples, the first retaining portion 260 may be, or include, one or more of the described magnetic structures 266, and the second retaining portion 262 may be, or include, one or more of the described magnets 264.

In some examples of the magnetic retention assembly 250, the one or more magnets 264 of the first retaining portion 260 could be permanent magnets configured to continuously produce a magnetic field for magnetically attracting the one or more magnetic structures 266 of the second retaining portion 262.

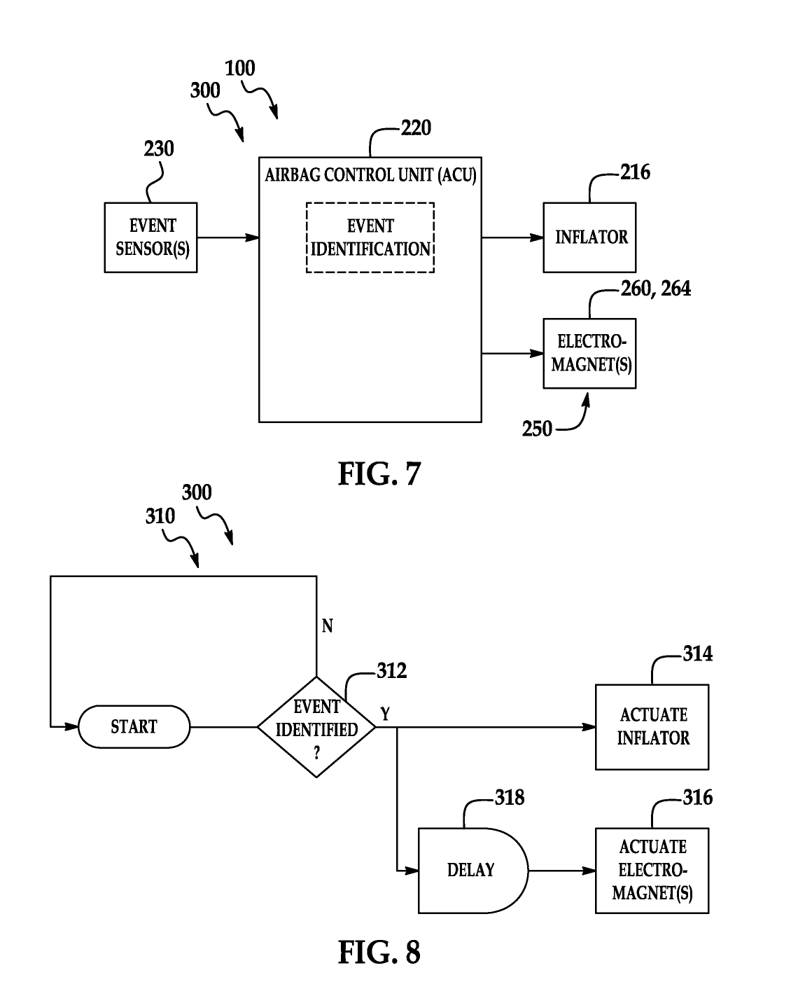

In other examples of the magnetic retention assembly 250, the one or more magnets 264 of the first retaining portion 260 could be electromagnets configured for the selective production of a magnetic field for magnetically attracting the one or more magnetic structures 266 of the second retaining portion 262. As shown with additional reference to FIG. 7, the side curtain airbag assembly 100 includes a system 300 for deploying the curtain airbag 200 and, according to the example of the magnetic retention assembly 250 where the one or more magnets 264 of the first retaining portion 260 are electromagnets, actuating the magnetic retention assembly 250.

The system 300 is generally configured to sense environmental conditions for the vehicle 10, identify one or more events for the vehicle 10 for which the curtain airbag 200 is configured to accommodate based on the sensed environmental conditions, and in response to the identified one or more events, selectively inflate the inflatable chamber 202 and actuate the magnetic retention assembly 250 to retain the curtain airbag 200 to the body structure 12 of the vehicle 10. The system 300 includes the one or more electromagnets 264 of the first retaining portion 260 and an inflator 216 fluidly coupled to the inflatable chamber 202 through the inflation aperture 208. The inflator 216 is configured to rapidly produce inflation gas for provision to the inflatable chamber 202 during inflation.

The system 300 further includes an airbag control unit (ACU) 220. The ACU 220 is communicatively coupled with one or more event sensors 230 that provide the ACU 220 with information concerning the environmental conditions for the vehicle 10. The ACU 220 is further communicatively coupled with the inflator 216 to allow the ACU 220 to selectively actuate the inflator 216, and with the one or more electromagnets 264 to allow the ACU 220 to selectively actuate the one or more electromagnets 264.

The ACU 220 may be one or multiple computers including a random access memory (RAM), a read-only memory (ROM) and a central processing unit (CPU) in addition to various input and output connections. Generally, the control functions of the ACU 220 described herein can be implemented by one or more software programs stored in internal or external memory and are performed by execution by the CPU. However, some or all of the functions could also be implemented by hardware components. It will be understood that the ACU 220 can be implemented as a dedicated controller for controlling the side curtain airbag assembly 100, and optionally other airbag assemblies, or, the ACU 220 can be embodied in other controllers of the vehicle 10.

As noted above, the ACU 220 is configured to identify one or more events for the vehicle 10 for which the curtain airbag 200 is configured to accommodate based on the environmental conditions for the vehicle 10 sensed by the one or more event sensors 230. The one or more event sensors 230 may be or include pressure sensors configured to sense the application of pressure to the exterior of the vehicle 10. The pressure sensors can be located in areas of the vehicle body structure 12 such as the front door 14 and the rear door 16, for instance, or in other portions of the vehicle body structure 12 such as the A-pillar 24, the B-pillar 22 or the C-pillar 26. Additionally, or alternatively, the one or more event sensors 230 may be or include accelerometers or other sensors configured to sense transverse acceleration of the vehicle 10. Additionally, or alternatively, the one or more event sensors 230 may be or include a gyro sensor or other sensor configured to sense rotation of the vehicle 10 about its longitudinal axis.

Example operations of a process 310 for implementation by the system 300 are shown in FIG. 8. In operation 312, if an event is identified, the inflator 216 is actuated in operation 314 to inflate the inflatable chamber 202 and provide coverage over the window opening 13 upon the ensuing entry of the curtain airbag 200 into the passenger compartment of the vehicle 10. Moreover, in operation 316, the one or more electromagnets 264 of the first retaining portion 260 are actuated to actuate the magnetic retention assembly 250. With the curtain airbag 200 deployed, the curtain airbag 200 will overlap portions of the body structure 12 and bring the one or more magnetic structures 266 of the second retaining portion 262 connected with the curtain airbag 200 into proximity with corresponding of the one or more electromagnets 264 housed by the body structure 12, and with the actuation of the one or more electromagnets 264, the one or more electromagnets 264 will magnetically attract the one or more magnetic structures 266 and retain the curtain airbag 200 to the body structure 12. Optionally, the process 310 can implement a delay in operation 318 prior to actuating the one or more electromagnets 264 in operation 316. The delay in operation 318 can be employed for instance with examples of the magnetic retention assembly 250 implementing one or more of the retention zone(s) Z1, Z2 or Z3 for the curtain airbag 200 to avoid the one or more electromagnets 264 of the second retaining portion 262 interfering with the deployment of the curtain airbag 200 by prematurely attracting the one or more magnetic structures 266 of the second retaining portion 262.

While the description herein is made with respect to specific implementations, it is to be understood that the invention is not to be limited to the disclosed implementations but, on the contrary, is intended to cover various modifications and equivalent arrangements included within the spirit and scope of the appended claims, which scope is to be accorded the broadest interpretation so as to encompass all such modifications and equivalent structures as is permitted under the law.

What is claimed is:

1. A vehicle, comprising:
a body structure defining a window opening;
a curtain airbag for the window opening, the curtain airbag sized to overlap some of the body structure upon its deployment; and
a magnetic retention assembly for retaining the curtain airbag to the body structure upon its deployment, the magnetic retention assembly having a first retaining portion positioned at a portion of the body structure overlapped by the curtain airbag, and a second retaining portion positioned at the curtain airbag, the second retaining portion magnetically attractable to the first retaining portion.

2. The vehicle of claim 1, wherein:
the curtain airbag is sized to have a peripheral portion overlap some of the body structure upon its deployment;
the first retaining portion is positioned at a portion of the body structure overlapped by the peripheral portion of the curtain airbag; and
the second retaining portion is positioned at the peripheral portion of the curtain airbag.

3. The vehicle of claim 1, wherein:
the curtain airbag is sized to have a central portion overlap some of the body structure upon its deployment;
the first retaining portion is positioned at a portion of the body structure overlapped by the central portion of the curtain airbag; and
the second retaining portion is positioned at the central portion of the curtain airbag.

4. The vehicle of claim 1, wherein one of the first retaining portion and the second retaining portion includes a magnet, and the other of the first retaining portion and the second retaining portion includes a magnetic material.

5. The vehicle of claim 1, wherein one of the first retaining portion and the second retaining portion includes an electromagnet subject to selective actuation, and the other of the first retaining portion and the second retaining portion includes a magnetic material.

6. The vehicle of claim 5, further comprising a system configured to deploy the curtain airbag and actuate the electromagnet, wherein the actuation of the electromagnet is delayed from the deployment of the curtain airbag.

7. The vehicle of claim 1, wherein the second retaining portion includes a flexible magnetic material configured to adapt to the contour of the portion of the body structure overlapped by the curtain airbag.

8. A vehicle, comprising:
a body structure defining a side window opening, the body structure forming a beltline framing a bottom of the side window opening;
a side curtain airbag for the side window opening, the side curtain airbag mounted at the top of the window opening and sized to span the height of the side window opening and have a lower periphery overlap the beltline upon its deployment; and
a magnetic retention assembly for retaining the side curtain airbag to the body structure upon its deployment, the magnetic retention assembly having a first retaining portion positioned at the beltline, and a second retaining portion positioned at the lower periphery of the side curtain airbag, the second retaining portion magnetically attractable to the first retaining portion.

9. The vehicle of claim 8, wherein:
the body structure includes an upright pillar at least partially framing the side window opening;
the side curtain airbag is sized to have a central portion overlap the upright pillar upon its deployment;
the first retaining portion is further positioned at the pillar; and
the second retaining portion is further positioned at the central portion of the side curtain airbag.

10. The vehicle of claim 8, wherein one of the first retaining portion and the second retaining portion includes a magnet, and the other of the first retaining portion and the second retaining portion includes a magnetic material.

11. The vehicle of claim 8, wherein one of the first retaining portion and the second retaining portion includes an electromagnet subject to selective actuation, and the other of the first retaining portion and the second retaining portion includes a magnetic material.

12. The vehicle of claim 11, further comprising a system configured to deploy the side curtain airbag and actuate the electromagnet, wherein the actuation of the electromagnet is delayed from the deployment of the side curtain airbag.

13. The vehicle of claim 8, wherein the second retaining portion includes a flexible magnetic material configured to adapt to the contour of the beltline.

14. A vehicle, comprising:
a body structure defining a window opening;
a curtain airbag for the window opening, the curtain airbag sized to overlap some of the body structure upon its deployment;
a first retaining portion housed by a portion of the body structure overlapped by the curtain airbag; and
a second retaining portion configured for magnetic attraction to the first retaining portion and connected with the curtain airbag for proximity with the first retaining portion upon the curtain airbag's deployment.

15. The vehicle of claim 14, wherein:
the first retaining portion is housed by a beltline of the body structure framing a bottom of the window opening; and
the second retaining portion is connected with a peripheral portion of the curtain airbag.

16. The vehicle of claim 14, wherein:
the first retaining portion is housed by an upright pillar of the body structure framing at least a portion of the window opening; and
the second retaining portion is connected with a central portion of the curtain airbag.

17. The vehicle of claim 14, wherein one of the first retaining portion and the second retaining portion includes a magnet, and the other of the first retaining portion and the second retaining portion includes a magnetic material.

18. The vehicle of claim 14, wherein one of the first retaining portion and the second retaining portion includes an electromagnet subject to selective actuation, and the other of the first retaining portion and the second retaining portion includes a magnetic material.

19. The vehicle of claim 18, further comprising a system configured to deploy the curtain airbag and actuate the electromagnet, wherein the actuation of the electromagnet is delayed from the deployment of the curtain airbag.

20. The vehicle of claim 14, wherein the second retaining portion includes a flexible magnetic material configured to adapt to the contour of the portion of the body structure overlapped by the curtain airbag.
